(19) United States
(12) Patent Application Publication
(10) Pub. No.: US 2002/0184538 A1
(43) Pub. Date: Dec. 5, 2002

(54) Combined authentication system

(75) Inventors: Masahiko Sugimura, Kawasaki (JP); Naoki Sashida, Kawasaki (JP); Hiroki Kitagawa, Kawasaki (JP); Shoji Hayakawa, Kawasaki (JP); Daiki Masumoto, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/093,490

(22) Filed: Mar. 11, 2002

(30) Foreign Application Priority Data
May 30, 2001 (JP) 2001-163144
Feb. 26, 2002 (JP) 2002-049740

(51) Int. Cl. H04L 9/32

(52) U.S. Cl. 713/202; 382/115

(57) ABSTRACT

A user authentication system that uses plural pieces of biometric information and secures a high security level is provided. Each biometric information and a combination of kinds of the biometric information are called combined biometric information. At the time of registration, plural kinds of user's biometric information are obtained via a biometric information input portion 10. A combined biometric information authentication strength calculating portion 30 calculates an authentication strength for each combined biometric information, wherein the authentication strength indicates how easy the user's biometric information is distinguished from evaluation biometric information in an evaluation biometric information storing portion 20. A combined biometric information determining portion 40 regards, as candidates, a series of the combined biometric information whose authentication strength satisfies an authentication strength required by an application, determines a combined biometric information to be used for the user authentication from among the candidates, and then notifies a combined biometric information registration portion 50 of it. At the time of authentication, the biometric information input portion 10 accepts an input of biometric information, and an authenticating portion 60 matches the registered combined biometric information in the combined biometric information registration portion 50 and the inputted combined biometric information.

### BACKGROUND OF THE INVENTION

1. Field of the Invention

The present invention relates to a user authentication system for authenticating a user by using biometric information, in which only access from a user who is allowed to access this user authentication system is accepted and then this user is authenticated. The present invention is applicable to technical fields that require user authentication by a machine, for example, financial transactions and purchasing of goods via the internet, ASP (Application Service Provider), electronized administrative procedures and outsourcing of corporate database management.

2. Description of Related Art

Accompanying a widespread use of the internet and cellular phones that has grown rapidly in recent years, there has been increasing opportunities to receive various services on the internet through terminals. Some of those provided services require user authentication. When conducting electronic commerce and a balance inquiry or an account settlement at a bank, it is necessary to authenticate a user via a network.

Conventionally, a password system has been used most widely as a user authentication system. This is adopted in various fields such as access to intra-company networks and ATM services.

As a user authentication system on the internet, using a digital certificate is now becoming mainstream. In this system, a user stores the digital certificate that has been issued by a credible organization in his/her personal computer, so that only the owner of this certificate can be authenticated as a true user.

In addition to the above authentication systems, a system utilizing biometric information (a biometric authentication) is now tried in various fields. The biometric authentication is a system of authenticating a user based on his/her biometric information such as an action pattern or the shape of a characteristic body portion. An increasing number of personal computers are provided with microphones to allow voice inputs, and thus, the user authentication by voices also is attracting an attention. Also, with the reduction in prices of CCD cameras in recent years, more and more personal computers are provided with these devices, and thus, the user authentication by facial images also is receiving an attention. Furthermore, user authentication systems using other various kinds of biometric information are now being developed.

The biometric authentication has the following advantages. First, the biometric information cannot be lent to others or shared with others. Second, a user does not have to remember the biometric information like a password. Third, there is no need to worry about losing this information as a card or a key. Fourth, since it is necessary to present a user's own biometric information at the time of the authentication, an unauthorized user can be specified easily when a crime occurs. This is expected to deter unauthorized uses. Fifth, the risk caused by unauthorized access can be predicted to a certain extent.

On the other hand, the biometric authentication has the following disadvantages. First, there are some cases where a user feels a certain mental resistance. Second, an input device is needed. Third, the authentication strength varies according to the condition of input devices and the change in environment. Fourth, there is a difference in availability of authentication and authentication strength between individuals. Fifth, there are some cases where the biometric information changes due to an injury from an accident or a varied health condition, making it impossible to authenticate the user.

The user authentication utilizing the password has the following problem. That is, in many cases, users choose their birth dates or phone numbers as their passwords so that they can remember them easily, thus raising susceptibility to unauthorized access.

The user authentication utilizing the digital certificate has the following problem. Even if a certain restriction is present on the access to the digital certificate because the digital certificate is stored in the user's personal computer, the access to the personal computer and the use of the digital certificate are restricted only by the password. As a result, when the personal computer, in which the digital certificate is stored, itself is stolen or subjected to unauthorized access, the security level drops down to that equivalent to the password after all.

Although several problems are pointed out with respect to the biometric authentication, the present invention especially focuses on the following problems.

First, in the biometric authentication, it is necessary that the user's own biometric information is registered first, and then biometric information is inputted again at the time of authenticating the user. In some cases, this makes the user feel mental resistance.

Second, there is a difference in the authentication strength between individuals or between kinds of the biometric information. In other words, there is a difference in the authentication strength between individuals depending on the distinctiveness of features in face, iris, voice or fingerprint or between kinds of such biometric information. In an application utilizing an input facial image for the authentication, for example, the authentication strength is different from one user to another, so that the security level against unauthorized access is different from one user to another.

In general, a user is authenticated by matching biometric information inputted when the user uses this application with biometric information registered as that of a true user. However, the biometric information of the true user varies along with change in health condition, aging, and an input environment. Accordingly, when a strict matching criterion is set, the rejection rate of a true user increases. On the other hand, when a lenient matching criterion is set, the acceptance rate of other users increases. In response to this, the matching criterion that is common to all the users has been adjusted at an appropriate level conventionally. However, there would be cases where even the true user is not accepted and cannot use the application and where other users are not rejected and abuse the application, because the authentication strength of the biometric information is different from one user to another.

### SUMMARY OF THE INVENTION

It is an object of the present invention to solve the problems described above and to provide a user authentication system that provides a user with a freedom of selecting biometric information desired to be used when authenticating the user and alleviates influence of difference in an authentication strength of the biometric information from one user to another, thereby maintaining a security level required in an application with respect to any users.

In order to achieve the above-mentioned object, a combined authentication system of the present invention includes a biometric information input portion for obtaining plural kinds of user's biometric information, an evaluation biometric information storing portion for registering, as evaluation biometric information, pieces of biometric information of a plurality of individuals for evaluating the user's biometric information, a combined biometric information authentication strength calculating portion for calculating an authentication strength for each combined biometric information that is each kind of the biometric information or each combination of the kinds of the biometric information, wherein the authentication strength indicates how easy the user's biometric information is distinguished from the evaluation biometric information, a combined biometric information determining portion for regarding, as candidates, a series of the combined biometric information whose authentication strengths satisfy an authentication strength required for a user authentication in an application, and then determining a combined biometric information to be used for the user authentication from among the candidates, a combined biometric information registration portion for registering the user's biometric information corresponding to the determined combined biometric information, and an authenticating portion for matching the registered combined biometric information that has been registered in the combined biometric information registration portion and the inputted combined biometric information, thus performing the user authentication.

With the above configuration, since the combined authentication system of the present invention obtains the authentication strength for each user and for each combined biometric information, it is possible to check if the combined biometric information satisfies an authentication strength required in the application for each user, thereby maintaining a certain security level for all users.

The “combined biometric information” in the present invention includes each kind of the biometric information (biometric information that is not combined with other biometric information) such as fingerprint information, voice print information or facial image information and a combination of the kinds of the biometric information (for example, a combination of fingerprint information and facial image information).

The combined authentication system of the present invention accepts inputs of the combined biometric information of a user who wants to use an application via the biometric information input portion at the time of using this application and matches the user's combined biometric information that has been registered in the combined biometric information registration portion and the inputted combined biometric information, thus performing the user authentication.

Next, in above configuration, it is preferable that the combined biometric information determining portion includes a notifying portion for notifying the user of the candidates of the combined biometric information, and a selecting portion for allowing the user to select the combined biometric information to be used for the user authentication from among the candidates of the combined biometric information.

The above configuration allows the user to select the combined biometric information that satisfies the authentication strength required in the application, thus giving the user freedom of selection.

In the above configuration, if the biometric information input portion is provided in a client system, and other portions are provided in a server system, with the client system and the server system being connected by a network, thereby configuring the combined authentication system of the present invention, this combined authentication system can be applied to a client/server system via the network. When the combined biometric information determining portion is provided with the selecting portion, this combined authentication system can be configured by providing the biometric information input portion and the selecting portion in the combined biometric information determining portion in a client system, and other portions in a server system, with the client system and the server system being connected via a network.

It is preferable that the user's biometric information obtained via the biometric information input portion is additionally registered into the evaluation biometric information storing portion as one sample. This is because an estimated accuracy of the authentication strength improves as the number of the pieces of registered biometric information increases.

Furthermore, it also is preferable that the combined biometric information authentication strength calculating portion has a function of tuning a parameter for each user, the parameter being used in the calculation of the authentication strength. This is because, by tuning the parameter for each user, it becomes possible to achieve a more suitable authentication strength.

Moreover, it also is preferable that the biometric information input portion is provided with an identifier for identifying an input device, and the authenticating portion performs the user authentication only when the identifier of the biometric information input portion used when registering the biometric information and that used when authenticating the user in the application are matched. By requiring that the access should be made from the same biometric information input device as that used for the registration, a certain restriction can be imposed on an unauthorized attempt of the user authentication from an unspecified site via the internet. More specifically, this can be realized by writing data such as numerals or characters as the identifier in a ROM or the like in the input device.

In addition to the combined authentication system using biometric information, other authentication systems such as a password authentication system can be used according to a user's selection. A password input portion, a password registration portion and a password authenticating portion are provided. If the user designates the combined use of the password authentication system, the authenticating portion performs the authentication by the biometric information only when passwords are successfully matched in the password authenticating portion. At this time, there is no particular limitation on the order in which the user inputs the password and the biometric information. As described above, the other authentication system is combined, thereby giving the user greater freedom of selection and improving a security level.

Next, a business model can be introduced in the use of the combined authentication system of the present invention. An example thereof includes a charging portion for determining an amount of charging a business entity managing the application or the user based on the combined biometric information to be registered into the combined biometric information registration portion and collecting the amount from the business entity managing the application or the user.

With the above configuration, the combined authentication system of the present invention can provide a service in which the combined biometric information to be used for authenticating the user is selected between the user and the business entity managing the application and registered at the time of registering biometric information. The value of this service can be charged depending on the combined biometric information. This also can be considered as the value of providing the user freedom of selecting the biometric information and the value of securing the security level required by the business entity managing the application.

Also, another business model can be introduced in the use of the combined authentication system of the present invention. An example thereof includes a charging portion for determining an amount of charging a business entity managing the application or the user based on the number of pieces of biometric information as samples registered into the evaluation biometric information storing portion and collecting the amount from the business entity managing the application or the user. This model is introduced in order to increase the number of pieces of evaluation biometric information registered in the evaluation biometric information storing portion. For this purpose, the fee for the kind of biometric information whose number is fewer is set lower so that this serves as an incentive for a new user to register the biometric information of this kind.

In addition, if an operation program code containing the processing operations for realizing the user authentication system according to the present invention is provided, the user authentication system according to the present invention can be constructed by computers by reading out a program on a computer-readable recording medium on which this program is recorded.

### BRIEF DESCRIPTION OF THE DRAWINGS

FIG. 1 is a drawing for describing a similarity parameter and the relationship between FAR and FRR used in a combined authentication system of the present invention.

FIG. 2 is a drawing for showing the classification of registered biometric information and input biometric information in the combined authentication system of the present invention.

FIG. 3 is a drawing for describing FAR and FRR with respect to a plurality of users used in the combined authentication system of the present invention.

FIG. 4 is a drawing for describing FAR and FRR with respect to individual users used in the combined authentication system of the present invention.

FIG. 5 is a drawing illustrating elements used when registering biometric information and elements used when authenticating a user used in a combined authentication system according to a first embodiment of the present invention.

FIG. 6 is a drawing for showing authentication strength required for each application used in the combined authentication system according to the first embodiment of the present invention.

FIG. 7 is a drawing for showing candidates of User A's combined biometric information.

FIG. 8 is a drawing for showing candidates of User B's combined biometric information.

FIG. 9 is a drawing for describing the results of whether the authentication strength of the User A's combined biometric information is sufficient or insufficient compared with the authentication strength required when authenticating the user of the application.

FIG. 10 is a drawing for describing the results of whether the authentication strength of the User B's combined biometric information is sufficient or insufficient compared with the authentication strength required when authenticating the user of the application.

FIG. 11 is a drawing illustrating elements used when registering biometric information and elements used when authenticating a user in a combined authentication system according to a second embodiment of the present invention.

FIG. 12 is a drawing illustrating elements used when registering biometric information and elements used when authenticating a user in a combined authentication system according to a third embodiment of the present invention.

FIG. 13 is a drawing illustrating a client/server configuration according to a fifth embodiment of the present invention.

FIG. 14 is a drawing illustrating another client/server configuration according to the fifth embodiment of the present invention.

FIG. 15 is a drawing illustrating another client/server configuration according to the fifth embodiment of the present invention.

FIG. 16 is a drawing illustrating another client/server configuration according to the fifth embodiment of the present invention.

FIG. 17 is a drawing illustrating a recording medium on which a processing program for realizing a combined authentication system according to a sixth embodiment of the present invention is recorded.

### DESCRIPTION OF THE PREFERRED EMBODIMENTS

First Embodiment

A combined authentication system of the present invention carries out a user authentication by utilizing combined biometric information. The “combined biometric information” in the present invention includes one kind of biometric information (biometric information that is not combined with other biometric information) such as fingerprint information, voice print information or facial image information and a combination of the kinds of the biometric information (for example, a combination of fingerprint information and facial image information). In addition, the combined authentication system of the present invention can authenticate a user by selecting one kind of the biometric information (for example, fingerprint information alone) as the combined biometric information or authenticate a user by selecting a combination of the kinds of the biometric information (for example, a combination of fingerprint information and facial image information) as the combined biometric information. The combined authentication system in accordance with the present invention calculates an authentication strength of each user and that of each combined biometric information, selects and utilizes the combined biometric information having the authentication strength that is required by an application.

First, the authentication strength in the case of using one kind of biometric information as the combined biometric information will be described.

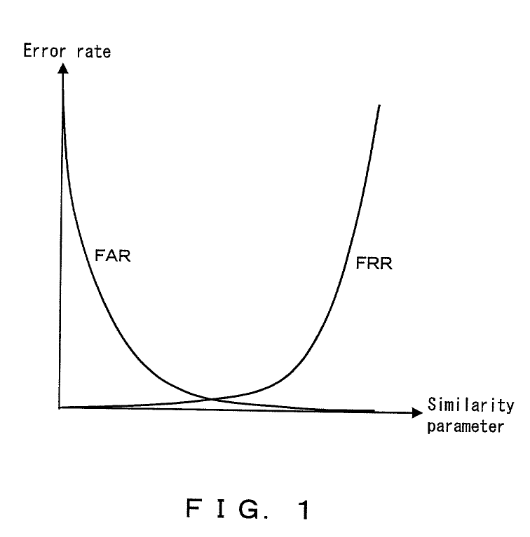

The authentication strength denotes how unlikely an authenticating error occurs, and in the biometric authentication, FAR (False Acceptance Rate), which is a case of accepting others falsely, and FRR (False Rejection Rate), which is a case of rejecting a true user falsely, are used as a quantitative expression. The horizontal axis in FIG. 1 indicates a threshold of similarity between input biometric information that is inputted at the time of authentication and registered biometric information that has been registered in the authentication system in advance (hereinafter, referred to as a similarity parameter). A method for calculating the similarity depends on an authentication algorithm. Because of a trade-off between FAR and FRR, their values are determined according to the similarity parameter. Furthermore, in the present invention, the authentication strength for a plurality of users is referred to as a cross-correlation authentication strength, and that for each user is referred to as an autocorrelation authentication strength, and they are dealt with separately.

FAR and FRR can be estimated by extracting two pieces of biometric information from a group of pieces of biometric information obtained from a plurality of individuals using an actual input device, assuming that one of them is the registered biometric information and the other is the input biometric information, applying an actual authentication algorithm and analyzing the authentication results of all the combinations. At this time, the preparation of a plurality of conceivable input devices allows a more accurate assumption. For simplicity of description, a general method for calculating the cross-correlation authentication strength in the case where 3 pieces of biometric information of the same kinds are present for 3 people respectively (in other words, there are 9 pieces of biometric information altogether) will now be outlined.

When 1 piece of biometric information is regarded as the input biometric information and the other 8 pieces of biometric information are regarded as the registered biometric information, the similarity of the input biometric information with respect to each registered biometric information is calculated. In other words, 8 similarity calculations are carried out for the 1 piece of biometric information. Then, this similarity calculation is carried out for every piece of biometric information. In other words, there are 72 combinations of the registered biometric information and the input biometric information. The similarity is calculated by actually applying a similarity calculation method used in the authentication algorithm to be employed.

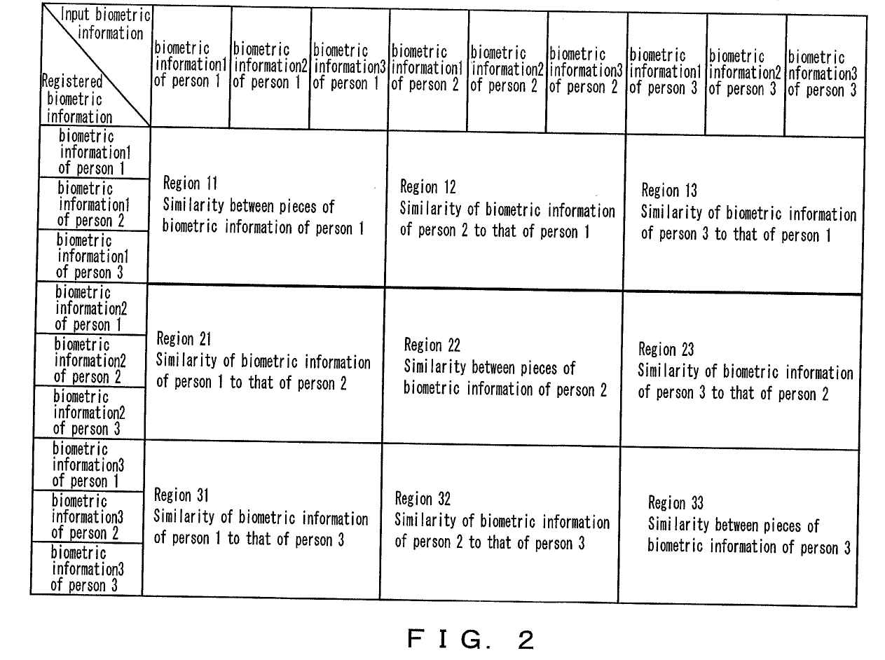

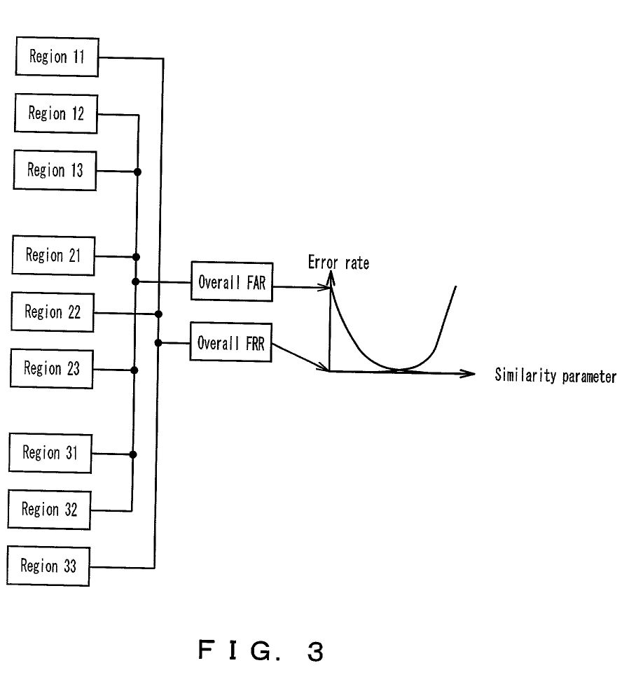

The resultant 72 similarities can be classified into 9 regions as shown in FIG. 2. When the threshold (the similarity parameter) to be accepted as the value of a true user is determined with respect to the similarities that have been calculated within sets of biometric information of one individual (Region 11, Region 22 and Region 33), each similarity can be categorized into “acceptance” and “rejection”. In this case, the ratio of “rejection” to the total number corresponds to FRR and is an increasing function with respect to the similarity parameter. Likewise, when the similarity parameter is determined with respect to the similarities that have been calculated from sets of biometric information of different individuals (Region 12, Region 13, Region 21, Region 23, Region 31 and Region 32), the ratio of “acceptance” to the total number corresponds to FAR. This is a decreasing function with respect to the similarity parameter (see FIG. 3).

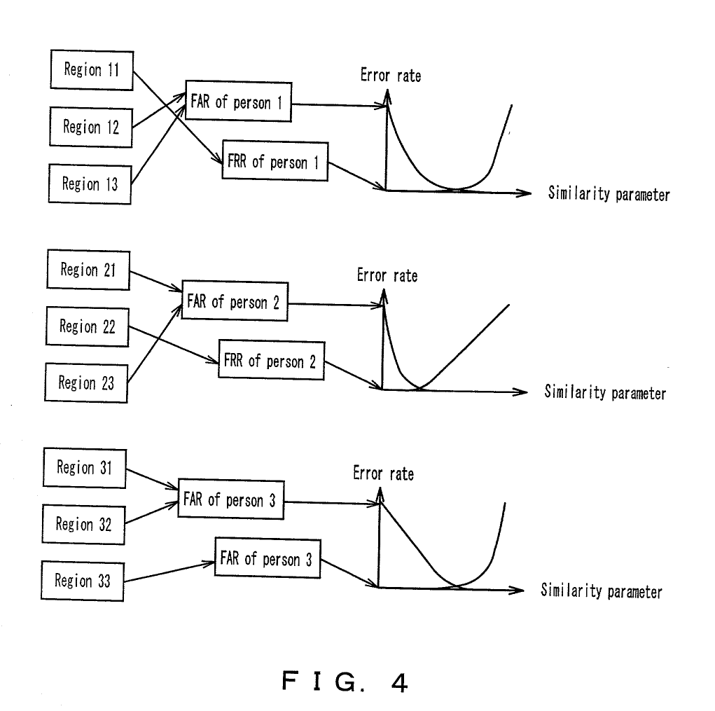

On the other hand, the autocorrelation authentication strength can be calculated as follows. In the case of Person 1, for example, FRR is calculated from the similarity in Region 11 and FAR is calculated from the similarities in Region 12 and Region 13 (see FIG. 4). Since the autocorrelation authentication strength is used in the present invention, it is understood that the authentication strength in the following description means the autocorrelation authentication strength.

An intersection point of graphs of FRR and FAR is called EER (Equal Error Rate). Although it is desirable that the value of EER ideally is 0%, it is not the case in reality. Instead, the cross-correlation authentication strength or a representative value (an average value, a minimum value, or the like) of the autocorrelation authentication strength that is calculated from biometric information collected for evaluation in advance is used generally as a nominal value of the performance of the biometric authentication. Although depending on which of FRR or FAR has a higher priority, the similarity parameter is set near EER in many cases.

The following is a description of an authentication strength when two or more kinds of biometric information are combined as the combined biometric information.

When two or more kinds of biometric information are combined, similarities of the combinations of the kinds of the biometric information are calculated first by actually applying an authentication system and a combination system to be employed. Then, each similarity is categorized into “acceptance” and “rejection” as in the case of using each kind of biometric information individually, so as to calculate FAR and FRR.

In this example of the first embodiment, when the individual authentication strength of each biometric information is calculated in each authentication system, a preset value is used as the similarity parameter described referring to FIG. 1. Since the relationship between the similarity parameter and the authentication strength is different from one user to another, it is possible to set a more suitable authentication strength by determining a similarity parameter for each user. This system of determining the similarity parameter for each user will be described again in the following embodiment.

Next, an example of the system configuration of the combined authentication system of the present invention will be described.

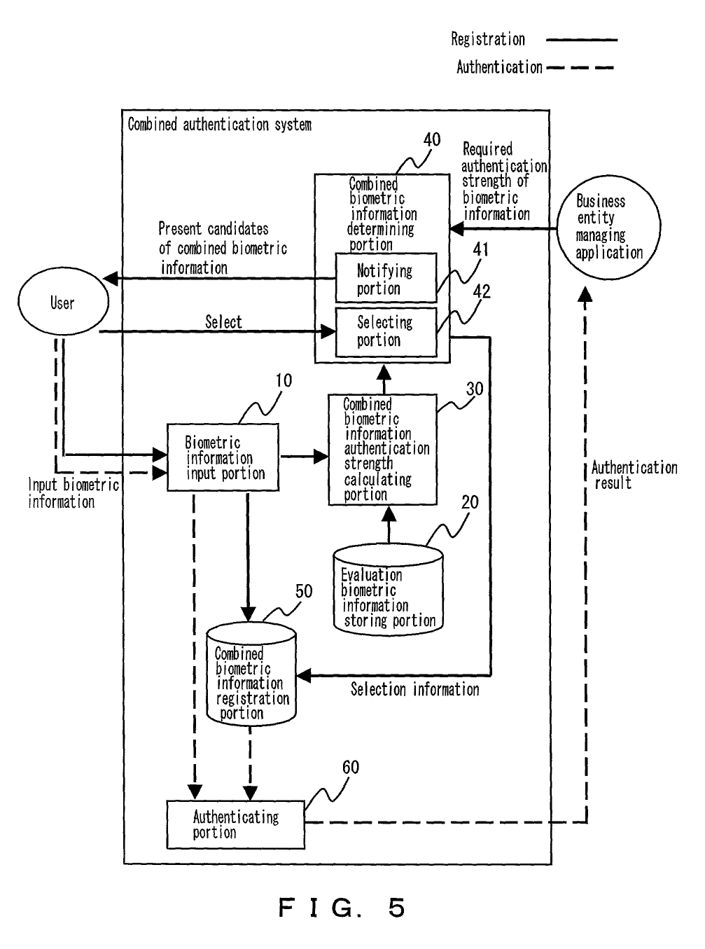

FIG. 5 is a drawing illustrating elements used when registering biometric information and elements used when authenticating a user in the combined authentication system according to the first embodiment of the present invention.

A biometric information input portion 10 is a portion for obtaining plural kinds of user's biometric information.

An evaluation biometric information storing portion 20 is a portion for storing and registering biometric information of many individuals to be samples.

A combined biometric information authentication strength calculating portion 30 is a portion for calculating an authentication strength for each combined biometric information, wherein the authentication strength indicates how easy the user's biometric information is distinguished from the evaluation biometric information. In other words, FAR and FRR of the user are calculated.

A combined biometric information determining portion 40 is a portion for regarding, as candidates, a series of the combined biometric information whose authentication strengths that have been calculated by the combined biometric information authentication strength calculating portion 30 satisfy the authentication strength required for a user authentication in the application and then determining a combined biometric information to be used for the user authentication from among the candidates.

This combined biometric information determining portion 40 in the first embodiment optionally has a function of allowing a user to select a desired combined biometric information to be used when authenticating the user. Accordingly, the combined biometric information determining portion 40 in the present embodiment includes a notifying portion 41 and a selecting portion 42.

The notifying portion 41 is a portion for notifying the user of the candidates of the combined biometric information whose authentication strengths satisfy the authentication strength required when authenticating the user of the application.

The selecting portion 42 is a portion for allowing the user to select a combined biometric information to be used when authenticating the user from among the candidates that have been notified of via the notifying portion 41.

For example, the notifying portion 41 presents the candidates of the combined biometric information as a list on a display of a user terminal. The user selects one combined biometric information among them via the selecting portion 42. The user may designate the combined biometric information with a pointing device such as a mouse or by a voice input. An interface is not specifically limited in the present invention.

A combined biometric information registration portion 50 is a portion for registering the user's biometric information inputted by the biometric information input portion 10. It also registers selection information of the combined biometric information to be used for authenticating the user, the selection information being determined and inputted by the combined biometric information determining portion 40. Incidentally, based on the selected combined biometric information registered in this combined biometric information registration portion 50, an inputted user's biometric information will be matched when authenticating the user. The combined biometric information registered in the combined biometric information registration portion 50 refers to the above selected combined biometric information among pieces of the biometric information registered in the combined biometric information registration portion 50.

The biometric information input portion 10, the evaluation biometric information storing portion 20, the combined biometric information authentication strength calculating portion 30, the combined biometric information determining portion 40 and the combined biometric information registration portion 50 described above are the elements used when registering biometric information in the combined authentication system according to the present invention.

An authenticating portion 60 is a portion for authenticating the user by matching the registered user's combined biometric information, which has been registered in the combined biometric information registration portion 50, and the user's combined biometric information inputted when authenticating the user.

Incidentally, a device used as the biometric information input portion 10 when registering the user's biometric information and that used when authenticating the user generally are different in some cases. However, the present embodiment has a configuration in which the same device is used both for registering the user's biometric information and for authenticating the user.

The biometric information input portion 10, the combined biometric information registration portion 50 and the authenticating portion 60 described above are the elements used when authenticating the user in the combined authentication system according to the present invention.

Next, an example of the application using the combined authentication system according to the present invention will be described.

The following is an example of applying the combined authentication system of the present invention to an authentication application of an on-line banking. Hereinafter, a business entity managing the application is referred to as “a bank”.

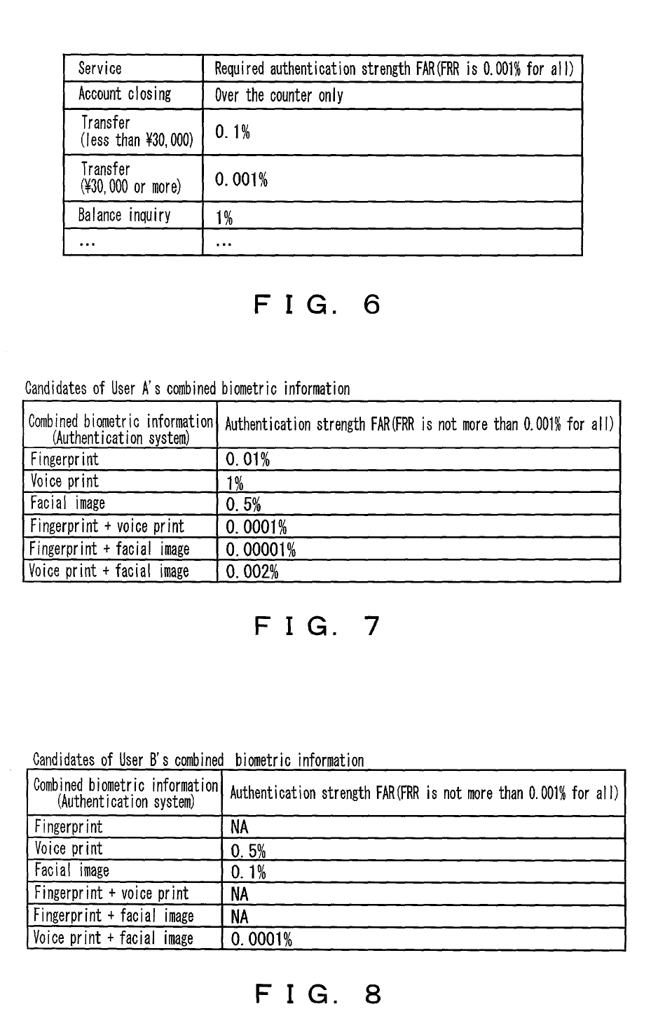

First, the bank determines required authentication strength according to a type of application services such as a transfer and a balance inquiry and notifies the combined authentication system of this authentication strength. The bank also selects a plurality of desired authentication systems to be adopted among authentication systems operated by the combined authentication system. In this example, three systems of a fingerprint authentication, a voice print authentication and a facial image authentication are adopted, and the authentication strength required for each application is set as shown in FIG. 6.

The following is an outline of the operation procedure of registering the user's biometric information.

First, when a user makes an application for the registration to the combined authentication system, the combined authentication system assigns a user identifier, which is unique to each user, to the user and notifies the user of it, and at the same time, writes the user identifier into a memory in a device and provides the user with it.

This device corresponds to the biometric information input portion 10, for instance, a fingerprint reader, a microphone and a camera in this example. Also, a driver or an application for making the device function is provided if necessary.

Next, the user registers his/her biometric information into the combined authentication system by using the provided biometric information input portion 10. The biometric information inputted via the biometric information input portion 10 may be stored in the combined biometric information registration portion 50 at this time.

With respect to the biometric information newly inputted via the biometric information input portion 10, the combined authentication system estimates its authentication strength in each authentication system based on the evaluation biometric information of many individuals that has been registered in the evaluation biometric information storing portion 20. In the present example, a value guaranteeing, at a certain probability, that FRR is 0.001% or lower for any individual is found by a simulation experiment, and this value is set as the similarity parameter for each system. Accordingly, it is appropriate to consider only FAR as the authentication strength.

First, the combined biometric information authentication strength calculating portion 30 calculates the authentication strength in each authentication system for each user and for each kind of the biometric information. In the present example, only FAR is calculated as the authentication strength. For example, User A's authentication strength FAR based on his/her fingerprint is 0.01%, that based on his/her voice print is 1%, and that based on his/her facial image is 0.5%.

Also, the combined biometric information authentication strength calculating portion 30 calculates the authentication strength in the case of combining two or more kinds of biometric information. In the present example, FAR is calculated using a combination system in which an authentication result in the case of combining the biometric information only when authentication results of the biometric information to be combined are all “acceptance” is considered “acceptance” and authentication results in the other cases are considered “rejection”. For example, the authentication strength FAR of the combination of the voice print and the facial image is 0.002%.

Then, the combined biometric information determining portion 40 extracts a candidate of the combined biometric information in which the calculated authentication strength FAR satisfies the authentication strength required when authenticating a user of the application.

In this case, the operation may be carried out for only a business entity managing an application or a service that is needed by the user. Also, when the user has already got his biometric information registered and needs a new service that is different from the registered service, the operation for the new service may be carried out alone.

FIGS. 7 and 8 show the authentication strengths of various combined biometric information for two users (User A and User B). FIG. 7 is for User A, while FIG. 8 is for User B. “NA (not available)” means that this authentication system cannot be used. For example, the section of fingerprint of User B says “NA” in FIG. 8. This indicates the case where the fingerprint of User B cannot be obtained, for instance, characteristic data cannot be obtained owing to abrasion of fingerprints or disability.

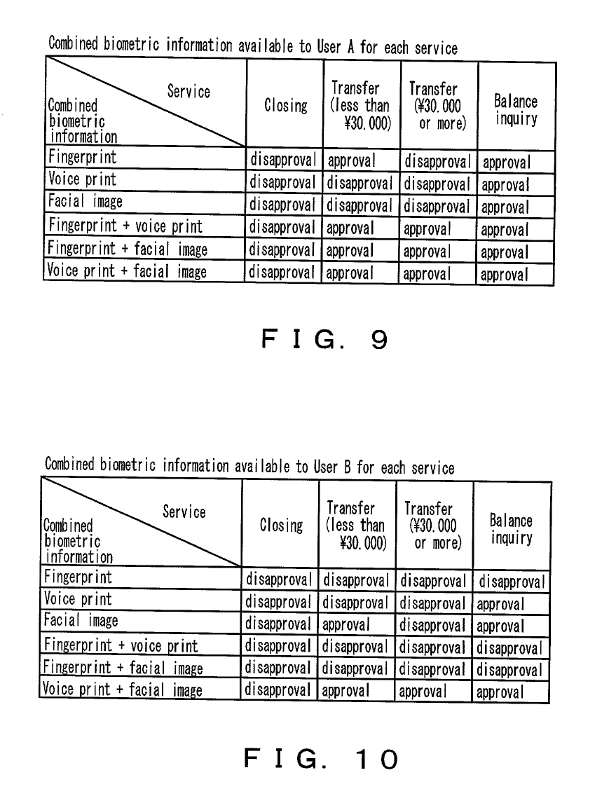

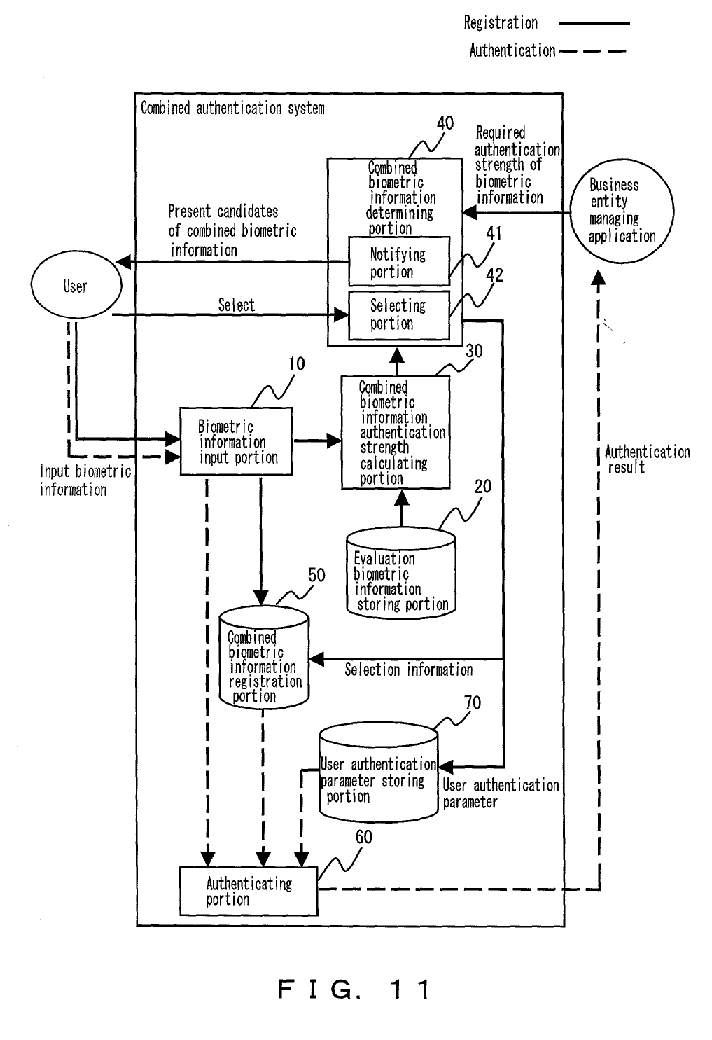

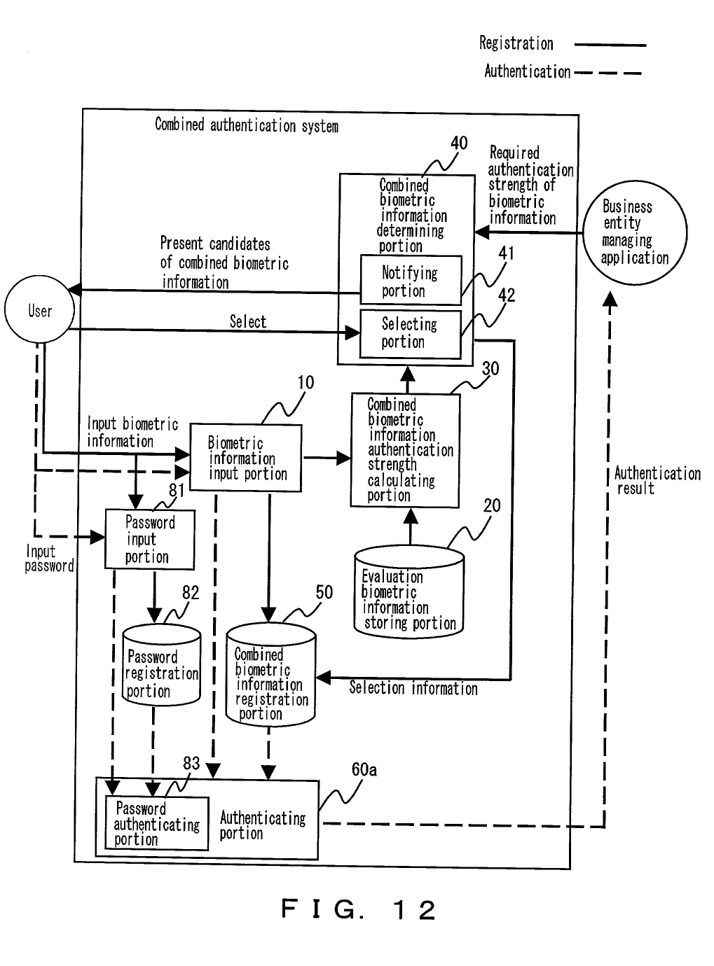

FIGS. 9 and 10 schematically show the results of whether the authentication strength of the candidates of the combined biometric information is sufficient or insufficient compared with the authentication strength required when authenticating the user of the application. In these figures, “approval” indicates that the authentication strength of each combined biometric information is sufficient for this application service menu, while “disapproval” indicates that it is not sufficient.

Incidentally, in the first embodiment, since the combined biometric information determining portion 40 has the notifying portion 41, it is possible to notify User A and User B of the list shown in FIG. 9 and the list shown in FIG. 10 respectively, for example.

Furthermore, in the first embodiment, since the combined biometric information determining portion 40 has the selecting portion 42, User A and User B can select the desired combined biometric information to be used when authenticating the user, for example, based on the list shown in FIG. 9 and the list shown in FIG. 10, respectively. It is possible to select a preferred authentication system among the ones that are available. For example, User A can select from among the fingerprint alone, the combination of the fingerprint and the voice print, the combination of the fingerprint and the facial image and the combination of the voice print and the facial image for the transfer of 30 thousand yen or more. On the other hand, User B can select the facial image alone or the combination of the voice print and the facial image for the transfer of 30 thousand yen or more. In this manner, each user can freely select the combined biometric information to be used for the user authentication.

As described above, the combined biometric information determining portion 40 determines the combined biometric information to be used when authenticating the user.

Next, the combined biometric information registration portion 50 is notified of the selection information of the determined combined biometric information to be used when authenticating the user. It is needless to say that the biometric information that is not included in the selected combined biometric information also can be registered in the combined biometric information registration portion 50 as attached information. Also, when the biometric information inputted via the biometric information input portion 10 has been stored temporarily in the combined biometric information registration portion 50, it may be possible to leave and register the biometric information to be registered definitively or to register the biometric information to be registered as main information and other biometric information as the attached information.

Moreover, for the purpose of increasing the number of samples in the evaluation biometric information storing portion 20, it is preferable that the user's biometric information that is inputted so as to be newly registered as a user is additionally registered into the evaluation biometric information storing portion 20 as a sample.

By following the operation procedure outlined above, the user's biometric information can be registered.

Next, the following is an outline of the operation procedure when authenticating the user.

First, when seeking a service of on-line banking, a user inputs his/her user identifier and biometric information according to a required combined biometric information via the biometric information input portion 10. Each inputted biometric information is transmitted to the authenticating portion 60.

The authenticating portion 60 matches the inputted combined biometric information with the user's combined biometric information that has been registered in the combined biometric information registration portion 50. The authenticating portion 60 determines whether or not the user authentication is approved based on the result of the matching and notifies the business entity managing the application of the decision.

The business entity managing the application allows this user to use the application only when the user is approved in this decision of the user authentication from the authenticating portion 60. When the user is disapproved in the decision of the user authentication, this business entity does not allow this user to use the application.

By following the operation procedure outlined above, the user can be authenticated.

Second Embodiment

In addition to the configuration of the first embodiment, a combined authentication system of the second embodiment has a configuration in which the combined biometric information authentication strength calculating portion has a function of tuning for each user a parameter used in the calculation of the authentication strength, thereby setting the parameter individually.

In the first embodiment, the description is directed to the example of using a common similarity parameter for all users when calculating the authentication strength.

Indeed, it is possible to use a common similarity parameter for all users when calculating the authentication strength as described above. However, because the relationship between the similarity parameter and the authentication strength is different from one user to another, it also may be possible to set a more suitable authentication strength by determining a similarity parameter for each user.

The similarity parameter can be determined by calculating similarity between the kinds of the biometric information, calculating authentication strengths for various similarity parameters, and then selecting a parameter value to be an authentication strength suitable for operating the application. According to a security level required by the application, the authentication strength may be set near EER or set such that FAR is minimum within the FRR range of 0, for example.

The similarity parameter in an authentication system using the combination of two or more kinds of biometric information also can be obtained by calculating authentication strengths with respect to the combinations of various values of each similarity parameter and selecting the one suitable for operating the application.

Furthermore, the algorithm and the input device of the biometric authentication generally include various parameters influencing the authentication strength other than the similarity parameter, and this influence is different from one user to another. The parameter in the algorithm can be set by calculating an optimal value in the combined authentication system. For example, it can be the length of utterance that is necessary for the voice print authentication or the significance of partial features of a face (an eye, a mouth, etc.) that contribute to the facial image authentication. Such an optimal value can be found experimentally by actually setting various parameter values and then calculating the authentication strengths. Accordingly, it may be possible to determine the similarity parameter and the parameter of the authentication algorithm for each user, record them in the combined authentication system, and then use the parameter suitable for the user when authenticating this user.

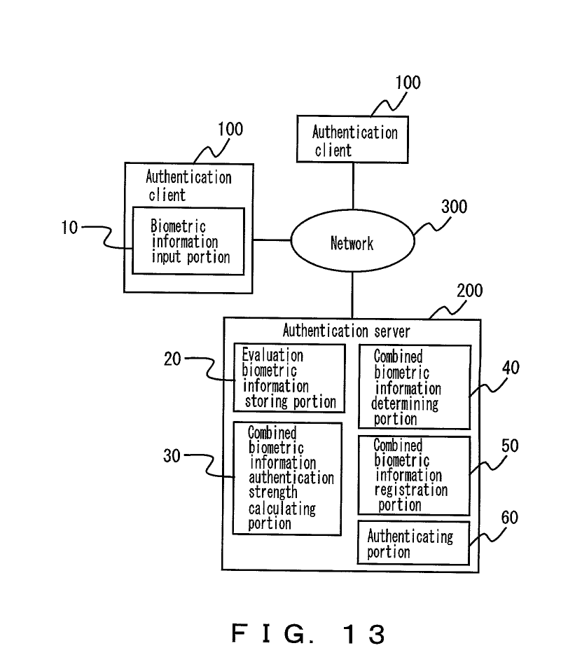

FIG. 11 is a drawing illustrating elements used when registering biometric information and elements used when authenticating the user in the combined authentication system according to the second embodiment.

In this figure, a user authentication parameter storing portion 70 is added to the configuration shown in FIG. 5.

The user authentication parameter storing portion 70 is a portion for storing the parameter set such that the authentication strength becomes optimal for each user. When authenticating the user, the matching is performed using the parameter stored in this user authentication parameter storing portion 70.

Third Embodiment The combined authentication system of the present invention can include other authentication systems such as a password authentication system or a digital certificate authentication system, in addition to the combined authentication system using biometric information. As a combined authentication system of the third embodiment, an example in which the combined authentication system described in the first embodiment etc. is combined with other authentication systems such as the password authentication system or the digital certificate authentication system according to a user's selection will be described. In this case, the user can determine whether or not the combination with the other authentication systems such as the password authentication system is necessary.

When registering the user, not only the biometric information but also a password or a digital certificate is registered, and not only the authentication strength of each system but also that of the password or the digital certificate is evaluated. In the case of the password or the digital certificate, since a true user will never be rejected unless this user forgets his/her password, it is appropriate to regard FRR as 0. In addition, considering the number of false acceptances in the past, an empirical value is set for FAR.

The authentication strength obtained by the combination with the biometric authentication can be calculated as follows.

(FRR when combined)=(FRR of biometric authentication)

(FAR when combined)=(FAR of biometric authentication)×(FAR of password or digital certificate)

FIG. 12 is a drawing illustrating elements used when registering the biometric information and elements used when authenticating the user in the combined authentication system according to the third embodiment. In this example, a password input portion 81, a password registration portion 82 and a password authenticating portion 83 are provided in addition to the configuration shown in FIG. 5. In the third embodiment shown in FIG. 12, the password authenticating portion 83 is included in an authenticating portion 60a.

It is assumed that the user has selected to use the password authentication system in addition to the combined authentication system using the biometric information. In this case, when registering the biometric information, the user selects the biometric information and also inputs a password to be adopted via the password input portion 81 so as to be registered into the password registration portion 82.

When the user is authenticated, the user inputs biometric information and also inputs a password via the password input portion 81. The password authenticating portion 83 matches the password inputted when authenticating the user with the registered password in the password registration portion 82. The authenticating portion 60a authenticates the user only when the passwords are successfully matched in the password authenticating portion 83. At this time, there is no particular limitation on the order in which the user inputs the password and the biometric information.

According to the third embodiment, in addition to the combined authentication system by the biometric information, the password authentication system also can be used according to the user's selection, thereby giving the user greater freedom of selection and improving a security level.

Fourth Embodiment

In the fourth embodiment, a business model is introduced in the use of the combined authentication system of the present invention.

The present embodiment includes a charging portion for determining an amount of charging a business entity managing an application or a user based on the number of pieces of biometric information to be samples registered into the evaluation biometric information storing portion and collecting the amount from the business entity managing the application or the user.

For instance, when there are two systems of Authentication System A and Authentication System B, which have the different number of registered users, it is possible to consider a method in which a fee in the case of adopting one of these authentication systems is determined by a ratio of the number of registered users and that in the case of adopting both Authentication Systems A and B is determined by a mean value of the both numbers of the registered users. In this method, when the number of the registered user for Authentication System A: the number of the registered user for Authentication System B=1:2, the fee for Authentication System A alone: the fee for Authentication System B alone: the fee for both Authentication Systems A and B=1:2:1.5. Consequently, the business entity can save the fee by adopting both Authentication Systems A and B rather than adopting Authentication System B alone.

With the above business model, services of various business entities are developed so as to correspond to various authentication systems, so that users who want to receive those services are encouraged to register their biometric information for these authentication systems, leading to an improved reliability of evaluation of the authentication strength.

Fifth Embodiment

The fifth embodiment is an example of constructing the combined authentication system of the present invention by a client/server system via a network.

With the widespread use of the internet, the construction of this system by a client/server system via a network is considered significant.

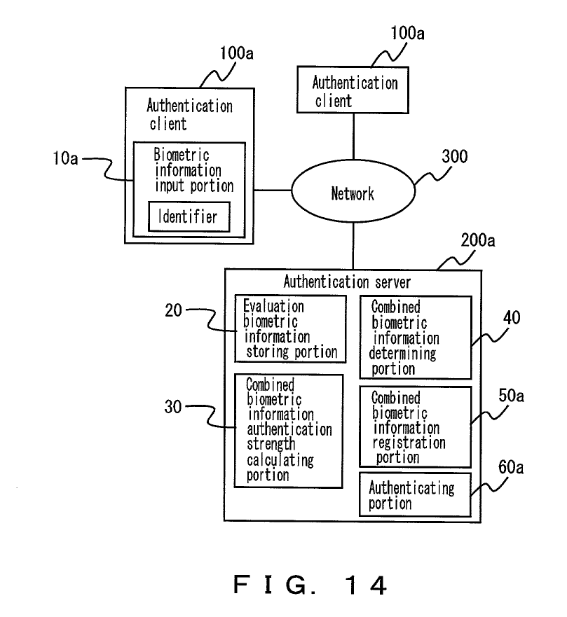

FIG. 13 illustrates an example of the client/server configuration. The biometric information input portion 10 is provided in an authentication client 100, and other elements such as the evaluation biometric information storing portion 20, the combined biometric information authentication strength calculating portion 30, the combined biometric information determining portion 40, the combined biometric information registration portion 50 and the authenticating portion 60 are provided in an authentication server 200. The authentication clients 100 and the authentication server 200 are connected via a network 300. This network 300 is, for example, the internet.

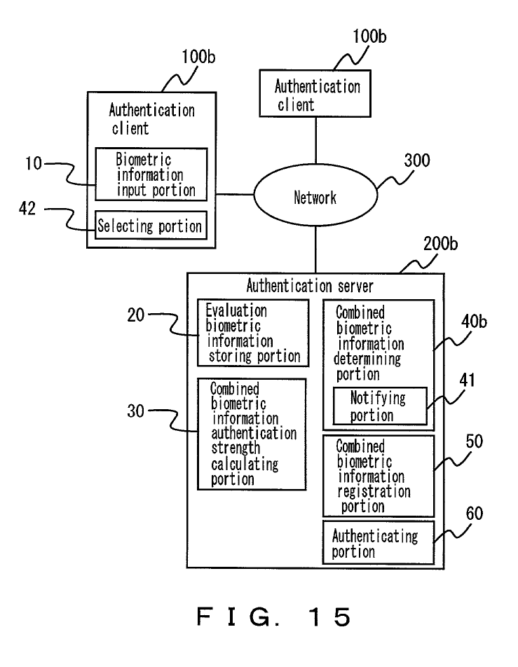

As shown in FIG. 14, an identifier may be provided in an biometric information input portion 10a serving as a biometric information input device, so that the authenticating portion 60 authenticates a user only when the identifier of the biometric information input portion used when registering the biometric information and the identifier of the biometric information input portion used when authenticating a user of this application are matched.

In general, the biometric authentication is easily influenced by an input device of the biometric information, and thus, it is difficult to ensure the authentication strength unless an appropriate input device is used. Accordingly, in the present embodiment, an identifier that is unique to a biometric information input device is added to this device in advance, and the user's identifier of the biometric information input device is recorded when registering the user. When authenticating the user, the correspondence of the identifier of the biometric information input device is checked. If this correspondence is not proper, the user authentication is rejected, warned or the like. Incidentally, when the biometric information input device is provided exclusively for a specific user, a username (a user identifier) can be used as the identifier.

In the case of using this identifier, the biometric information input portion 10a stores identifier information. When registering the user, not only the inputted biometric information but also this identifier information is transmitted to a combined biometric information registration portion 50a. Also, when authenticating the user, not only the inputted biometric information but also this identifier information is transmitted to an authenticating portion 60a.

In addition to the biometric information, the combined biometric information registration portion 50a stores the identifier information of the biometric information input portion 10a in association with this biometric information.

Prior to or at the same time with the matching of the biometric information inputted when authenticating the user and the biometric information registered in the combined biometric information registration portion 50a, the authenticating portion 60a checks if the identifier of the biometric information input portion 10a achieves proper correspondence.

According to this embodiment, the kinds of the biometric information input devices can be limited. Therefore, it becomes possible to eliminate a device unsuitable for an authentication system of the combined authentication system or to designate a biometric information input device suitable for each user, thus raising the authentication strength. Also, by using the same biometric information input device, there no longer is variation in characteristics between the biometric information input device used by the user at the time of the registration and that used by the user at the time of the user authentication, thus improving reliability of the authentication strength and the authentication strength evaluation. In addition, even when the biometric information input device used for the registration and that used when authenticating the user are not the same, as long as they are the same type of devices produced by the same manufacturer, higher reliability can be achieved compared with the case of using an arbitrary biometric information input device.

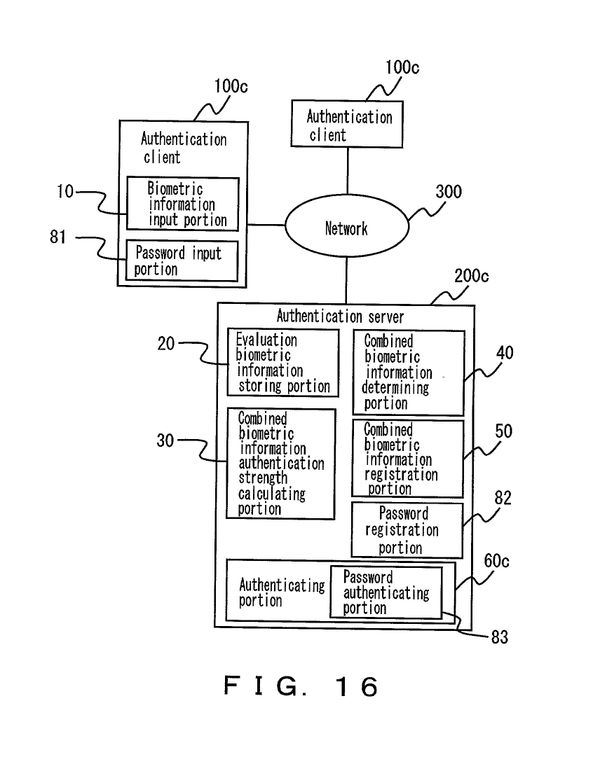

FIG. 15 illustrates another example of the client/server configuration. In this example, the notifying portion 41 and the selecting portion 42 are provided as described in the first embodiment as an option. In constructing as the client/server system, the notifying portion 41 is provided on the side of an authentication server 200b, and the selecting portion 42 is provided on the side of an authentication client 100b. In other words, the biometric information input portion 10 and the selecting portion 42 are provided in the authentication client 100b, and other elements such as the evaluation biometric information storing portion 20, the combined biometric information authentication strength calculating portion 30, the combined biometric information determining portion 40b (except for the selecting portion 42), the notifying portion 41, the combined biometric information registration portion 50 and the authenticating portion 60 are provided in the authentication server 200b. The authentication clients 100b and the authentication server 200b are connected via the network 300.

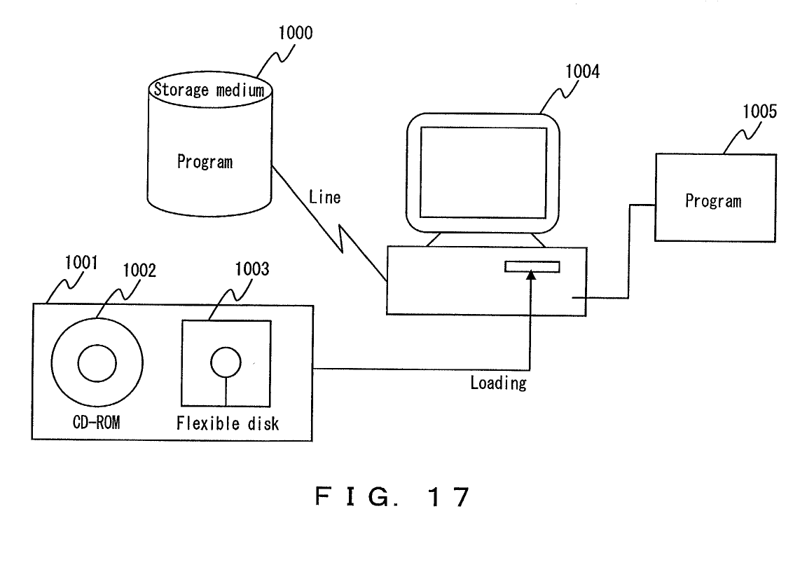

FIG. 16 illustrates another example of the client/server configuration. In addition to the biometric information input portion 10, the password input portion 81 is provided in an authentication client 100c, and the password registration portion 82 and the password authenticating portion 83 are provided in an authentication server 200c. Then, the authentication clients 100c and the authentication server 200c may be connected via the network 300. Although the password authenticating portion 83 is provided in an authenticating portion 60c in the configuration of FIG. 16, it does not have to be provided in the authenticating portion 60c.

Sixth Embodiment

The user authentication system according to the present invention can be constructed by computers of several types by recording a program, containing the processing operations for realizing the configurations explained above, on a computer-readable recording medium. The recording medium, on which the program providing the processing operations realizing the user authentication system according to the present invention is recorded, can be not only a portable recording medium 1001 such as a CD-ROM 1002 or a flexible disk 1003, but also a recording medium 1000 in a recording apparatus on the network or a recording medium 1005 such as a hard disk or a RAM in the computer. When executing the program, the program is loaded into a computer 1004 and executed in its main memory.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A combined authentication system comprising:
a biometric information input portion for obtaining plural kinds of user's biometric information;
an evaluation biometric information storing portion for registering, as evaluation biometric information, pieces of biometric information of a plurality of individuals for evaluating the user's biometric information;
a combined biometric information authentication strength calculating portion for calculating an authentication strength for each combined biometric information that is each kind of the biometric information or each combination of the kinds of the biometric information, wherein the authentication strength indicates how easy the user's biometric information is distinguished from the evaluation biometric information;
a combined biometric information determining portion for regarding, as candidates, a series of the combined biometric information whose authentication strengths satisfy an authentication strength required for a user authentication in an application, and then determining a combined biometric information to be used for the user authentication from among the candidates;
a combined biometric information registration portion for registering the user's biometric information corresponding to the determined combined biometric information; and
an authenticating portion for matching the registered combined biometric information that has been registered in the combined biometric information registration portion and the inputted combined biometric information, thus performing the user authentication.

2. The combined authentication system according to claim 1, wherein the biometric information input portion is provided in a client system, and other portions are provided in a server system, with the client system and the server system being connected by a network.

3. The combined authentication system according to claim 1, wherein the combined biometric information determining portion comprises a notifying portion for notifying the user of the candidates of the combined biometric information, and a selecting portion for allowing the user to select the combined biometric information to be used for the user authentication from among the candidates.

4. The combined authentication system according to claim 3, wherein the biometric information input portion and the selecting portion in the combined biometric information determining portion are provided in a client system, and other portions are provided in a server system, with the client system and the server system being connected via a network.

5. The combined authentication system according to claim 1, wherein the user's biometric information obtained via the biometric information input portion is additionally registered into the evaluation biometric information storing portion as one sample.

6. The combined authentication system according to claim 1, wherein the combined biometric information authentication strength calculating portion has a function of tuning a parameter for each user, the parameter being used in the calculation of the authentication strength.

7. The combined authentication system according to claim 1, wherein the biometric information input portion is provided with an identifier, and the authenticating portion performs the user authentication only when the identifier of the biometric information input portion used when registering the biometric information and that used when authenticating the user in the application are matched.

8. The combined authentication system according to claim 1, further comprising a password input portion, a password registration portion and a password authenticating portion,
wherein the user can select to use a user authentication system using a password in addition to a user authentication system using the biometric information, and if the user selects to use both the systems, the authenticating portion performs the user authentication only when passwords are successfully matched in the password authenticating portion.

9. The combined authentication system according to claim 1, further comprising a charging portion for determining an amount of charging a business entity managing the application or the user based on the combined biometric information to be registered into the combined biometric information registration portion and collecting the amount from the business entity managing the application or the user.

10. The combined authentication system according to claim 1, further comprising a charging portion for determining an amount of charging a business entity managing the application or the user based on the number of the pieces of the biometric information as samples registered into the evaluation biometric information storing portion and collecting the amount from the business entity managing the application or the user.

11. A combined authentication method comprising:
obtaining plural kinds of user's biometric information;
registering pieces of biometric information of a plurality of individuals to be samples as evaluation biometric information;
calculating an authentication strength for each combined biometric information that is each kind of the biometric information or each combination of the kinds of the biometric information, wherein the authentication strength indicates how easy the user's biometric information is distinguished from the evaluation biometric information;
regarding, as candidates, a series of the combined biometric information whose authentication strengths satisfy an authentication strength required for a user authentication in an application, and then determining a combined biometric information to be used for the user authentication from among the candidates;
registering the biometric information corresponding to the determined combined biometric information; and
matching the registered combined biometric information that has been registered and the inputted combined biometric information of the user, thus performing the user authentication.

12. A combined authentication program for authenticating a user by using plural kinds of user's biometric information, the program comprising the operations of:
obtaining the plural kinds of the user's biometric information;
registering pieces of biometric information of a plurality of individuals to be samples as evaluation biometric information;
calculating an authentication strength for each combined biometric information that is each kind of the biometric information or each combination of the kinds of the biometric information, wherein the authentication strength indicates how easy the user's biometric information is distinguished from the evaluation biometric information;
regarding, as candidates, a series of the combined biometric information whose authentication strengths satisfy an authentication strength required for a user authentication in an application, and then determining a combined biometric information to be used for the user authentication from among the candidates;
registering the biometric information corresponding to the determined combined biometric information; and
matching the registered combined biometric information that has been registered and the inputted combined biometric information of the user, thus performing the user authentication.
